(19) United States
(12) Patent Application Publication
(10) Pub. No.: US 2009/0327110 A1
(43) Pub. Date: Dec. 31, 2009

(54) METHOD AND SYSTEM FOR MANAGING ELECTRONIC BILLS

(75) Inventor: Cheng-Chieh Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/406,089

(22) Filed: Mar. 17, 2009

(30) Foreign Application Priority Data
Jun. 30, 2008 (CN) 200810302418.2

(51) Int. Cl. G06Q 30/00

(52) U.S. Cl. 705/34

(57) ABSTRACT

A method and system for managing electronic bills in an electronic device are provided. The method includes defining keywords of a short message; receiving the short message on the electronic device; determining whether the short message relates to the electronic bill; and extracting transaction data of the short message and generating a transaction record accordingly in response to a determination of the electronic bill.

### BACKGROUND

1. Field of the Invention

Embodiments of the present disclosure relate to electronic bills, and more particularly to a method and a system for managing electronic bills on a portable electronic device.

2. Description of Related Art

With the rapid development of mobile services, short message service (SMS) is one of the most widely utilized mobile services. The SMS broadcast service allows a short message to be delivered to all the users in a specific area, and the point-to-point SMS transmits a message to a specific user, such as sending bills to their customers.

Generally, such bill messages only relate to reminders for notifying the users of the information of the bill. The user can only passively receive the bill messages, and cannot request personalized information. Furthermore, the user can not edit the bill messages, or calculate the total amount of the electronic bills according to his request.

Accordingly, a method and a system for managing electronic bills on a portable electronic device are called for in order to overcome the limitations described.

### BRIEF DESCRIPTION OF THE DRAWINGS

FIG. 1 is a block diagram of an embodiment of a system for managing electronic bills; and

FIG. 2 is a flowchart of an embodiment of a method for managing electronic bills.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

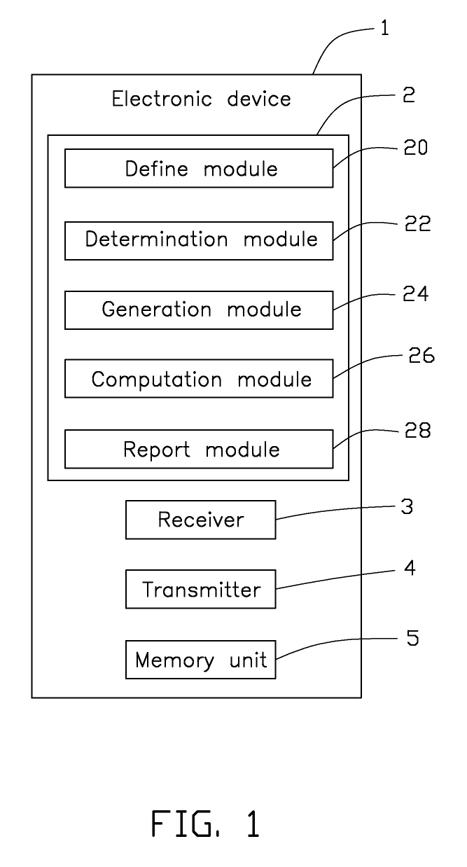

FIG. 1 is a block diagram of an embodiment of a system 2 for managing electronic bills (hereinafter “the system 2”). An electronic device 1, such as a mobile phone, includes a receiver 3 and a transmitter 4 for receiving and transmitting short messages, a memory unit 5, and the system 2 for managing electronic bills received on the electronic device 1. Portable and non-portable electronic devices other than the mobile phone shown here, such as notebook computers and personal digital assistants (PDAs), for example, may equally utilize the system 2, without departing from the spirit of the disclosure.

In one embodiment, the system 2 includes a define module 20, a determination module 22, a generation module 24, a computation module 26, and a report module 28 in addition to other hardware and software components of the system 2.

The define module 20 is configured for defining keywords of a received short message for indentifying the electronic bills. The keywords include identification numbers of financial institutions and detail items of the short message, where information in the short message indicate monetary transactions between a user of the system 2 and a financial institution, such as a bank, a clothing store, or a supermarket, for example. The identification numbers of the financial institutions relate to the service numbers of the financial institutions from which the short messages are sent. For example, if the identification numbers of the financial institution sending the electronic bill is “95588,” then the identification number “95588” is registered as one of the keywords. In one embodiment, the detail items may also indicate other transaction data, such as the items purchased and names of stores.

The define module 20 is further configured for providing a menu for receiving manually inputted transaction data. For example, the user may manually input transaction data such as date, item, store, and an amount of a transaction by the menu provided by the define module 20. The inputted data are stored in the memory unit 5 so that the inputted transaction data may be calculated together with the electronic bills sent by the short messages. In addition, the users may query, delete, and edit transaction data by the menu provided by the define module 20. The menu may be in the form of a graphical user interface in one example.

The determination module 22 is configured for determining whether the short message is related to the electronic bill according to the keywords contained in the short messages in response to receipt of the short message. For the above example, if the short message is sent from the service number “95588,” the short message would be considered as the electronic bill. In addition, if the short message contains keywords such as names of the stores that have been registered as keywords, the short message is also considered as the electronic bill. For example, if “GAP” is registered as a keyword, the short message is related to be the electronic bill if the electronic bill contains the word “GAP.”

The generation module 24 is configured for extracting transaction data of the short message and generating transaction records accordingly in response to a determination of the electronic bill. For example, upon determining the short message is related to the electronic bill, the generation module 24 extracts the transaction data and saves information corresponding to the transactions, such as shopping items and names of stores, as one transaction record. It is to be noted that the transaction data contained in one electronic bill is saved as one transaction record.

In one embodiment, the system 2 further includes a computation module 26 and a report module 28.

The computation module 26 is configured for providing a plurality of computation modes and for computing a total amount of the transaction record of respective computation modes according to the transaction records. For example, the computation modes include computing the total amount of the transaction records by date, by month, by stores, and so on.

The report module 28 is configured for generating transaction reports according to the transaction records and computation modes. In addition, the report module 28 is further configured for selecting detail items of the reports, and for displaying the reports according to the detail items. For example, the user may select to display only the date and the total amount of the transaction records occurring within a week and in a specific shop.

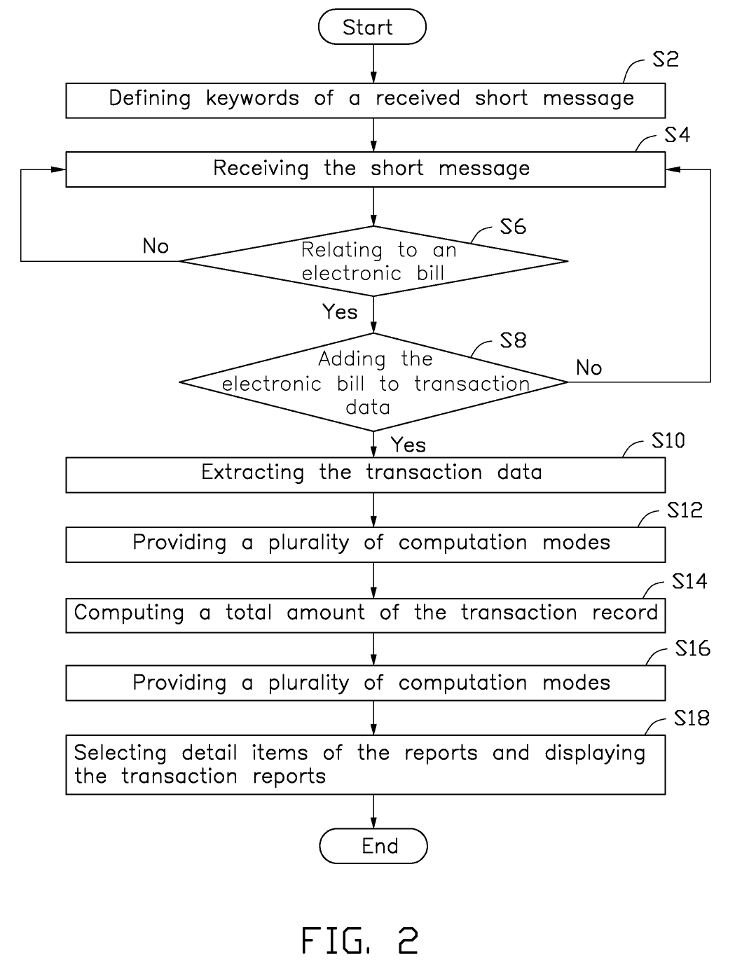

FIG. 2 is a flowchart of an embodiment of a method for managing electronic bills. The method of FIG. 2 may used for inputting, editing, or calculating transaction records basing on the electronic bills. Depending on the embodiment, additional blocks may be added or deleted and the blocks may be executed in order other than that described.

In block S2, the define module 20 defines keywords of a received short message, where the keywords are indicative of transactions and identification numbers of financial institutions. In block S4, the electronic device 1 receives the short message.

In block S6, the determination module 22 determines whether the short message relates to the electronic bill according to the keywords in the short message or the identification number of the short message. It may be understood that other identifying data may also be used to identify the short message to the electronic bill.

If the short message relates to the electronic bill, in block S8, the determination module 22 determines whether the electronic bill has to be added to the transaction data. Otherwise, the process goes back to block S4 to repeat the above-mentioned processing.

In block S10, the generation module 24 extracts the transaction data of the short message and generates transaction records accordingly. In one embodiment, the transaction records generated by the generation module 24 are saved in the memory unit 5 of the electronic device 1.

In block S12, the computation module 26 provides a plurality of computation modes, such as computing by time period, by financial institutions, or by stores. In block S14, the computation module 26 computes a total amount of the transaction records by using at least one selected computation mode. For example, the total amount of the transaction records within a specific period regarding a specific store may be computed.

In block S16, the report module 28 selects detail items of the reports and then displays the report according to the selected detail items.

It is important to note that while the disclosure has been described in the context of a fully functioning data processing system, those of ordinary skill in the art will appreciate that the processes of the disclosure are capable of being distributed in the form of a computer readable medium of instructions and a variety of forms and that the disclosure applies equally regardless of the particular type of signal bearing media actually used to carry out the distribution. Examples of computer readable media include recordable-type media such as floppy disc, a hard disk drive, random access memory (RAM), and compact disc-read only memory (CD-ROM), as well as transmission-type media, such as digital and analog communications links.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for managing electronic bills, the system comprising:
a define module configured for defining keywords of a received short message, the short message indicating a transaction record and an identification number of a financial institution;
a determination module configured for determining whether the short message relates to an electronic bill according to the keywords in the short message or the identification number of the short message in response to receipt of the short message; and
a generation module configured for extracting transaction data of the short message and generating a transaction record accordingly in response to a determination of the electronic bill.

2. The system as claimed in claim 1, further comprising a computation module configured for providing a plurality of computation modes, and for computing a total amount of the transaction record of respective computation modes according to the transaction record.

3. The system as claimed in claim 2, further comprising a report module configured for generating transaction reports according to the transaction record and the computation modes.

4. The system as claimed in claim 3, wherein the report module is further configured for selecting detail items of the transaction records, and for displaying the transaction records according to the detail items.

5. The system as claimed in claim 1, wherein the define module is further configured for providing a menu to receive manually inputted transaction data.

6. A method for managing an electronic bill in an electronic device, the method comprising:
defining keywords of a short message, the short message indicating a transaction record and an identification number of a financial institution;
receiving the short message on the electronic device;
determining whether the short message relates to the electronic bill according to the keywords in the short messages or the identification number of the short message; and
extracting transaction data of the short message and generating a transaction record accordingly in response to a determination of the electronic bill.

7. The method as claimed in claim 6, further comprising:
providing a plurality of computation modes; and
computing a total amount of the transaction record of respective computation modes according to the transaction record.

8. The method as claimed in claim 7, further comprising:
generating transaction reports according to the transaction record and the computation modes.

9. The method as claimed in claim 8, further comprising:
selecting detail items of the transaction reports; and
displaying the transaction reports according to the detail items.

10. The method as claimed in claim 6, further comprising:
receiving the transaction records inputted manually.

11. A computer-readable medium for managing an electronic bill in an electronic device, the computer-readable medium having stored thereon instructions that, when executed by the electronic device, cause the electronic device to:
define keywords of a short message, the short message indicating a transaction record and an identification number of a financial institution;
receive the short message on the electronic device;
determine whether the short message relates to the electronic bill according to the keywords in the short messages or the identification number of the short message; and
extract transaction data of the short message and generating a transaction record accordingly in response to a determination of the electronic bill.

12. The computer-readable medium claimed in claim 11, wherein the instructions, when executed by the electronic device, further cause the electronic device to:
provide a plurality of computation modes; and
compute a total amount of the transaction record of respective computation modes according to the transaction record.

13. The computer-readable medium as claimed in claim 12, wherein the instructions, when executed by the electronic device, further cause the electronic device to:
generate transaction reports according to the transaction record and the computation modes.

14. The computer-readable medium as claimed in claim 13, wherein the instructions, when executed by the electronic device, further cause the electronic device to:
select detail items of the transaction reports; and
display the transaction reports according to the detail items.

15. The computer-readable medium as claimed in claim 11, wherein the instructions, when executed by the electronic device, further cause the electronic device to:
receive the transaction records inputted manually.
